(19) United States
(12) Patent Application Publication
(10) Pub. No.: US 2010/0023750 A1
(43) Pub. Date: Jan. 28, 2010

(54) System and Method for Controllably Concealing Data from Spying Application

(75) Inventor: Teewoon Tan, New South Walles (AU)

Correspondence Address: MICHAEL MOLINS;MOLINS & CO., SUITE 5, LEVEL 6, 139 MACQUARIE ST, SYDNEY NSW, 2000, AU

(73) Assignee: Encassa Pty Ltd, Pyrmont (AU)

(21) Appl. No.: 12/282,648

(22) PCT Filed: Mar. 21, 2006
(86) PCT No.: PCT/AU06/00379

§ 371 Date: Sep. 11, 2008

(30) Foreign Application Priority Data
Jul. 14, 2005 (AU) 2005903842

(51) Int. Cl. H04L 9/00; G06F 13/00

(52) U.S. Cl. 713/150

(57) ABSTRACT

A method for use in controllably concealing an input data that has been entered into a computer system via an input device, from being comprehended by a spying application during transportation of the input data across a communication link of the computer system, the method including the steps of: (i) encrypting the input data when the input data is being processed at a relatively low level within the computer system so as to form an encrypted input data; (ii) thereafter, transporting the encrypted input data across the communication link; (iii) thereafter, providing a device for decrypting the encrypted input data so as to obtain a decrypted input data; (iv) selectively providing access to the decrypted input data by at least one authorised software application operably connected to the computer system.

### FIELD OF THE INVENTION

The present invention relates to the field of anti-spyware, anti-keylogging, and anti-phishing technologies and the like which are used to prevent malicious users from secretly obtaining sensitive user input information from a computer system.

### BACKGROUND OF THE INVENTION

The Internet is increasingly being used to facilitate e-commerce transactions which frequently involve the transfer of sensitive user information including such things as passwords and credit card details online. The increased usage of the Internet as a means of facilitating e-commerce transactions has also resulted in a proliferation of “spyware”, “key-logging” and “phishing” software applications which are designed to exploit weak-spots in the Internet, or the underlying computing systems therein, whereby sensitive user data such as credit card details and passwords can be secretly accessed by unauthorised parties.

It is not uncommon for instance, for security breaches to occur during the actual transportation of sensitive user data from one location to another within a computer system or a network of computer systems. One approach to dealing with this problem has been to use an encryption means such as the Secure Sockets Layer (SSL) protocol which encrypts the sensitive user data at a relatively high level.

It is also common for security breaches to occur within the user's computer system, for instance, when data is being entered into a secure web page.

Typically, a computer virus, a trojan, and/or a worm may be used to secretly install spying software within the user's computer system which is adapted to monitor the user's keystrokes, mouse movement, Internet usage history and/or screenshots. This information can be retrieved by unauthorised third parties and exploited without the user's knowledge to the detriment of the user.

Certain spying applications specifically target the Microsoft Windows operating system typically using the “Windows Hooks” facility to intercept messages and events before and after appropriate Windows procedures have been called. Existing approaches to countering these types of security breaches have involved monitoring for processes that register new Windows Hooks and then preventing these operations from taking place, or, terminating the suspect processes. However, this approach is inconvenient given that it also tends to block non-malicious programs which may have a valid use of the Windows Hooks functionality.

In general, there are various spying systems which operate in different ways, and, it is difficult to effectively counter all such systems simultaneously. Moreover, in some cases, the spying software must first be identified before an appropriate counter-response can be effectively implemented, and, as spying software become more sophisticated, the ability to detect the presence of and remove such spying applications is increasingly problematic.

The proliferation of “phishing” websites also pose a security risk to users. These websites are designed to have the same look and feel as a legitimate website. Users are usually guided to these websites by fake, and usually spam, emails. Users, lulled into a false sense of security, enter sensitive information into these fake websites.

### SUMMARY OF THE INVENTION

The present invention seeks to alleviate at least one of the problems described above in relation to prior art systems.

The present invention involves several different broad forms. Embodiments of the invention may include one or any combination of the different broad forms herein described.

In a first broad form, the present invention provides a method for use in controllably concealing an input data that has been entered into a computer system via an input device, from being comprehended by a spying application during transportation of the input data across a communication link of the computer system, the method including the steps of:
(i) encrypting the input data when the input data is being processed at a relatively low level within the computer system so as to form an encrypted input data;
(ii) thereafter, transporting the encrypted input data across the communication link;
(iii) thereafter, providing a device for decrypting the encrypted input data so as to obtain a decrypted input data;
(iv) selectively providing access to the decrypted input data by at least one authorised software application operably connected to the computer system.

Preferably, the relatively low level includes at a device driver level.

Typically, the input data is encrypted within the input device via which the input data is entered into the computer system.

Preferably, the step of encrypting input data includes using a mapping procedure to map the input data to an encrypted input data format. Typically, the input data includes a plurality of input data symbols which are mapped into a plurality of corresponding encrypted input data symbols using the mapping procedure. Preferably, the mapping procedure is varied after a predetermined number of input data symbols in the input data have been mapped to corresponding encrypted input data symbols. Typically, the mapping procedure is randomly varied. Alternatively, the mapping procedure is selectively varied by a user.

Preferably, the present invention includes the step of recording details of each mapping procedure used to map each input data symbol to a corresponding encrypted input data symbol. Also preferably, the recorded details of each mapping procedure used in encrypting the input data is stored as an encryption information.

Preferably, the step of encrypting input data includes the use of a stream cipher. More preferably, the stream cipher includes an RC4-type cipher.

Preferably, the present invention also includes the step of interspersing the encrypted input data with random data to form an interspersed encrypted input data. Typically the present invention includes a preceding step of generating random data. Typically, the random data is generated using a random data generator. Typically, the random data generator includes at least one of:
a device driver;
a user-controlled software application.

Preferably, the present invention includes the step of varying a rate at which the random data is generated. Typically, the rate at which random data is generated may be varied randomly. Alternatively, the rate at which random data is generated may be varied in accordance with a user selection.

Preferably, the random data that is generated includes a characteristic that is indicative of the input data processed at a relatively low level. Typically, the characteristic includes a statistical similarity between the random data and the input data processed at a relatively low level.

Preferably, the present invention includes a step of recording details of how the random data is interspersed with the encrypted input data. Typically, the recorded details are stored as an interspersion information.

Preferably, the present invention includes the step of providing a device for extracting the encrypted input data from the interspersed encrypted input data by reference to the interspersion information. Typically, the device for extracting the encrypted input data from the interspersed encrypted input data includes a device driver. Also typically, the device for decrypting the encrypted input data so as to obtain a decrypted input data includes a device driver.

Preferably, the present invention includes the step of providing the encryption information to the device for decrypting the encrypted input data whereby the device decrypts the encrypted input data by reference to the encryption information.

Preferably, the present invention includes the step of encrypting the encryption information before providing it to the device for decrypting the encrypted input data. Typically, the device for decrypting the encrypted input data is provided with an encryption key for decrypting the encrypted encryption information.

Preferably, the present invention includes the step of extracting encrypted input data from the interspersed encrypted input data, and, the step of decrypting the encrypted input data is performed by the same device.

Typically, the step of encrypting the input data, and, the step of interspersing the encrypted input data with random data, are performed by the same device.

Typically, the present invention includes the step of selectively providing access to the decrypted input data by at least one authorised software application.

In a second broad form, the present invention provides a method for use in controllably concealing an input data that has been entered into a computer system via an input device, from being comprehended by a spying application during transportation of the input data across a communication link of the computer system, the method including the steps of:
(i) generating random data;
(ii) thereafter, interspersing the random data with the input data when the input data is being processed at a relatively low level within the computer system so as to form an interspersed input data;
(iii) thereafter, transporting the interspersed input data across the communication link;
(iv) thereafter, providing a device for extracting the input data from the interspersed input data;
(v) selectively providing access to the extracted input data by at least one authorised software application operably connected to the computer system.

Preferably, the relatively low level includes at a device driver level. Typically, the input data is interspersed with random data within the input device via which the input data is entered into the computer system.

Preferably, the random data is generated using a random data generator. Typically, the random data generator includes at least one of:
a device driver;
a user-controlled software application.

Preferably, the present invention includes the step of varying a rate at which the random data is generated. Typically, the rate at which random data is generated is varied randomly. Alternatively, the rate at which random data is generated is varied in accordance with a user selection.

Preferably, the random data that is generated includes a characteristic that is indicative of the input data processed at a relatively low level. Typically, the characteristic includes a statistical similarity between the random data and the input data processed at a relatively low level.

Preferably, the present invention includes the step of recording details of how the random data is interspersed with the input data. Preferably, recorded details are stored as an interspersion information.

Preferably, the present invention includes the step of providing a device for extracting the input data from the interspersed input data by reference to the interspersion information. Typically, the device for extracting the input data from the interspersed input data includes a device driver. Preferably, the present invention includes the step of encrypting the interspersed input data before the interspersed input data is transported across the communication link. Preferably the step of encrypting the interspersed input data includes using a mapping procedure to map the interspersed input data to an encrypted interspersed input data format. Typically, the input data includes a plurality of interspersed input data symbols which are mapped into a plurality of corresponding encrypted interspersed input data symbols using the mapping procedure. Typically, the mapping procedure is varied after a predetermined number of interspersed input data symbols in the input data have been mapped to corresponding encrypted interspersed input data symbols. Also typically, the mapping procedure may be randomly varied. Alternatively, the mapping procedure may be selectively varied by a user.

Preferably, the present invention includes the step of recording details of each mapping procedure used to map each interspersed input data symbol to a corresponding encrypted interspersed input data symbol. Typically, the recorded details of each mapping procedure used in encrypting the interspersed input data is stored as an encryption information.

Typically, the step of encrypting the interspersed input data includes the use of a stream cipher. Typically, the stream cipher includes an RC4-type cipher.

Preferably, the present invention includes the step of providing a device for decrypting the encrypted interspersed input data so as to extract the interspersed input data. Typically, the device for decrypting the encrypted interspersed input data so as to extract the interspersed input data includes a device driver.

Typically, the present invention includes the step of providing the encryption information to the device for decrypting the encrypted interspersed input data whereby the device decrypts the encrypted interspersed input data by reference to the encryption information.

Typically the encryption information may itself be encrypted before being provided to the device for decrypting the encrypted interspersed input data. Typically, the device for decrypting the encrypted interspersed input data is provided with an encryption key for decrypting the encrypted encryption information.

Typically, the step of decrypting the encrypted interspersed input data, and, the step of extracting the input data from the interspersed input data is performed by the same device.

Typically, the present invention includes the step of selectively providing access to the extracted input data by at least one authorised software application.

Preferably, the random number generator is cryptographically strong.

The step of encrypting and/or interspersing input data includes the use of an “input handler. The term “input handler” may typically encompass at least one of:
a device driver,
a chain of interconnected device drivers;
a device stack;
a device driver in series with an operating system input handler, or, an interrupt handler.

Typically, the input handler may be able to read data entered into the computer system via a physical input device. The input handler may be disposed in the physical input device itself.

The input handler may receive random data from an external random data generator with which to intersperse with input data. Alternatively, the input handler may include an internal random data generator.

The step of decrypting and/or extracting input data includes the use of “an input descrambler” which may also typically encompass at least one of:
a device driver,
a chain of interconnected device drivers;
a device stack;
a device driver in series with an operating system input handler, or, an interrupt handler.

Typically, the input handler and the input descrambler are operably connected whereby, encrypted and/or interspersed input data produced by the input handler is communicated to the input descrambler.

Preferably, the step of encrypting input data may typically occur in addition to any encryption procedures performed on the scrambled input data at a higher level—for instance, by way of the Secure Sockets Layer encryption (SSL) protocol.

Typically, the interspersing of random data into input data occurs at random locations. Typically, the interspersing of random data into encrypted input data occurs at random locations.

Typically, the encryption step may include the use of a trusted public key.

Typically, the present invention includes the step of communicating the scrambled input data to the authorised software application. This step may further include the use of an operating system disposed on the computer system. For instance, the input handler may pass the scrambled input data to the operating system which in turn may distribute the scrambled input data towards at least one of:
an appropriate authorised software application; or
an operating system API hook.

Typically, the input descrambler is communicatively connected to at least one authorised software application and is able to communicate the descrambled input data to the authorised software application.

It would be understood by a person skilled in the art that the authorised software application and the input device via which input data is entered may reside on separate computers which may be remotely connected, for instance, via the Internet. This may for instance arise where a user is entering credit card detail into a Web site using a first computer terminal and the input data is transmitted via the Internet to a remote server for processing by a software application running on the remote server.

Advantageously the present invention alleviates problems associated with prior art anti-spying approaches in that, input data is scrambled and/or encrypted at a low level, prior to the data being distributed by an operating system to running applications, thus controllably concealing the input data from spying applications. Prior art, such as the SSL-protocol, are generally susceptible to spying applications, because it they tend to conceal data only after the input data has been passed through potential points of relative vulnerability. By providing protection through random data interspersion and/or encryption at a low level, the present invention may assist in facilitating secure end-to-end system transfer of sensitive input data.

The use of encryption may be performed using the public key of a trusted user. The encrypted data is then transferred to the destination computing machine. The destination computing machine may possibly be only accessible via a network or the Internet. The destination computing machine contains a private key that is used to decrypt the encrypted input data. This method can be used to mitigate the threat of phishing. In this case, a phishing website pretending to be a trusted site prompts the user to enter sensitive information. However, the input data is encrypted with a trusted site's public key. The phishing website has extremely low probability of decrypting the encrypted input data without the trusted site's private key.

In certain embodiments, the present invention may include the further step of selectively concealing the display of extracted input data on a monitor—for instance where an authorised software application attempts to automatically display received input data on the monitor.

The input data that is out presented on the monitor by the authorised software application, may typically be concealed using a “top-most window” to block the display of the input data. The term “top-most window”, is commonly used in relation to the Windows Operating System platform to describe a window which is always positioned to at least partially conceal an underlying window. In this manner, the threat of unauthorised screen captures being performed by spying application can be mitigated.

Typically, the above step may involve the further steps of:
(i) determining a set of co-ordinates indicative of a location on a display to which input data will be presented;
(ii) generating a top-most window having a set of dimensions and a positioning on the display whereby the top-most window at least partially obscures underlying input data.

In a third broad form, the present invention provides a system for use in controllably concealing an input data that has been entered into a computer system via an input device, from being comprehended by a spying application during transportation of the input data across a communication link of the computer system, the computer system including a processor communicatively connected to:
the input device;
   a memory store which is adapted to store a computer program,
      wherein the processor is operative with the computer program to perform the method steps in accordance with the first broad form of the present invention.

In a fourth broad form, the present invention provides a system for use in controllably concealing an input data that has been entered into a computer system via an input device, from being comprehended by a spying application during transportation of the input data across a communication link of the computer system, the computer system including a processor communicatively connected to:
the input device;
a memory store which is adapted to store a computer program, wherein the processor is operative with the computer program to perform the method steps in accordance with the second broad form of the present invention.

In a fifth broad form, the present invention provides a computer-readable medium having stored thereon, a data structure generated in accordance with the method steps of at least any one of the first and/or second broad forms of the present invention.

In a computerised system, a user-interface including a display and a selection device, a method of providing and selecting from a menu on the display, the method steps in accordance with at least any one of the first and/or second broad forms of the present invention.

In a sixth broad form, the present invention provides a method of using at least one processing module provided in accordance with at least one of the third and/or fourth broad forms of the present invention.

Typically, the communication link of the computer system includes a communication link between a device driver and an authorised application.

Typically, the input data is communicated between the device driver and the authorised application via a first processing module and a second processing module respectively whereby the first and second processing modules are adapted to perform any one of the method steps in accordance with any one of the above-described broad forms of the present invention.

Typically, the device driver includes a device driver of a keyboard input device.

Typically, the authorised application includes a Web browser.

Typically, the step of initialising an encryption protocol across the communication link between the first and second processing modules using the first and second processing modules respectively.

Typically, the step of initialising the encryption protocol across the communication link between the first and second data processing modules includes the first and second processing modules exchanging an encryption key.

Typically, the second processing module includes a data filter operatively connected to the authorised application. A typical example of a data filter may include one or more hooks, such as operating system application programming interface (API) hooks that may be adapted to both intercept encrypted keyboard data, and, to decrypt that encrypted data prior to being sent to one or more applications.

Typically, the data filter is adapted to receive data destined for at least one of a set of windows, a set of applications, a set of processes, and/or a set of threads. Preferably, the data filter receives encrypted data via the communication link which have been encrypted by the first processing module, and decrypts the encrypted data.

Preferably, the first processing module includes the use of a first random data provider and the second processing module includes the use of a separate second random data provider.

Typically, the first and second random data providers are disposed in at least one of a USB-compatible, serial-port, or peripheral device. Also typically, the USB-compatible device is adapted to communicate via a maximum of two connections at any given time. Typically, the two connections include connections to:
the device driver; and
the authorised software application.

Typically, each of the first and second random data providers includes a communications module. Also typically, the communications modules are adapted to communicate via a maximum of two connections at any given time. Typically, the two connections include connections to:
the device driver;
the authorised software application;
the first random data provider; and
the second random data provider.

In certain embodiments, the first and/or second random data providers may be restricted to communicate via a maximum of one connection at any given time. In this arrangement, the first random data provider may typically be restricted to communicating via a connection with the device driver, whilst the second random data provider may typically be restricted to communicating via a connection to the authorised software application only.

Preferably, the present invention includes the use of a controller to control operation of at least the first and second random data providers and the first and second processing modules. Preferably the present invention includes the step of the controller monitoring the number of active connections made with the first and/or second random data providers at any given time. Also preferably, the present invention includes the step of generating an alert whenever the controller detects that more than 2 connections have been made with any one of the first and/or second random data providers.

Preferably, the present invention includes the steps of: receiving input data from the input device; encrypting, scrambling and/or interspersing the input data using data provided by the first random data provider; sending a first signal from the first processing module to the second processing module that comprises the data filter; on receiving the first signal from the first processing module, transmitting a second signal to the controller whereby the controller then communicates with the first processing module to receive the encrypted, scrambled and/or interspersed input data; operating the input descrambler and second random data provider to extract the input data from the received encrypted, scrambled and/or interspersed input data; transmitting the extracted input data to the authorised application via the second processing module. Preferably, the controller, second random data provider, and/or input descrambler may operate with one or more authorised applications.

Typically, the device driver encrypts input data using a symmetric cipher. Also typically, the symmetric cipher includes one-time pad encryption.

### DEFINITIONS

The term “spying application” is defined to include any software and/or hardware application which may be adapted to secretly monitor and/or record data from a computer system. Spying applications may commonly encompass, “spyware”, “key-logging” applications and the like. For instance, spying applications are typically perceived to facilitate the recording of sensitive input data such as passwords or credit card details by detecting keystroke sequences on a keyboard, mouse movements, screenshots, and/or computer usage histories.

Preferably, the reference to a “computer system” includes both a stand-alone computer system, as well as, a plurality of computer systems inter-connected via a communication link such as the Internet, a local-area-network, a wide-area-network or any other suitable communication means known to persons skilled in the art.

Preferably, the reference to an “input device” may include physical devices such as a keyboard, a mouse, a camera, a scanner, a microphone. Alternatively, the input device may also include a software device such as a device driver, an interrupt handler and the like.

Preferably, the reference to “input data” includes data being indicative of at least one of the following:
data that has been generated by a physical input device at the point of entry into the computer system;
data that has been read by a device driver from a physical input device;
data that has been generated, processed, and/or output from a device driver.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 depicts a prior art computer configuration in which a spying or keylogging application is able to listen to unprotected input data.

FIG. 2 depicts a schematic view of first embodiment of the present invention interfaced with a computer system input device and various software applications.

FIG. 3 depicts a schematic view of the first embodiment of the present invention in stand-alone fashion.

FIG. 4 depicts a schematic view of a first and a second implementation of the first embodiment of the present invention interfaced together in a chained configuration.

FIG. 5A depicts a schematic view of a first embodiment of an input handler which may be implemented with the first embodiment of the present invention.

FIG. 5B depicts a schematic view of a second embodiment of an input handler which may be implemented with the first embodiment of the present invention.

FIG. 5C depicts a schematic view of a third embodiment of an input handler which may be implemented with the first embodiment of the present invention.

FIG. 6 depicts a schematic view of a first and second implementation of the first embodiment of the present invention residing in separate computer systems remotely which is interconnected via the Internet.

FIG. 7 depicts a flowchart outlining the steps involved in the operation of an input handler used in the implementation of the first embodiment of the present invention.

FIG. 8 depicts a flowchart outlining the steps involved in the operation of a random data provider used in the first embodiment of the present invention.

FIG. 9 depicts a flowchart outlining the steps involved in the operation of an input descrambler used in the first embodiment of the present invention.

FIG. 10 depicts a flowchart outlining the steps involved in the operation of a controller used in the first embodiment of the present invention, where the controller includes a user interface.

FIGS. 11A-11E depict a series of schematic views of a further embodiment of the present invention.

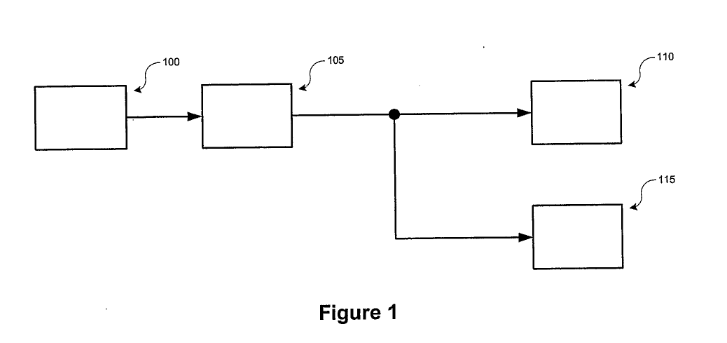

FIG. 1 depicts a prior art computer system in which input data is vulnerable to exploitation by a spying application 110 which secretly records data entered by the user. In the prior art system, user input data which is entered via a physical input device 100 is read by an input handler 105 such as a device driver, and interrupt handler or the like. One embodiment of the input handler 105 in a prior art system comprises at least one device driver and at least one input handling component of an operating system of the computer system that is also herein referred to as the operating system input handler, where the operating system input handler distributes the input data to at least one software application, such as software application 115. A software application 115 receives data from the input handler 105 but this input data is also readily accessible and comprehendible by the spying application 110 without the user's knowledge.

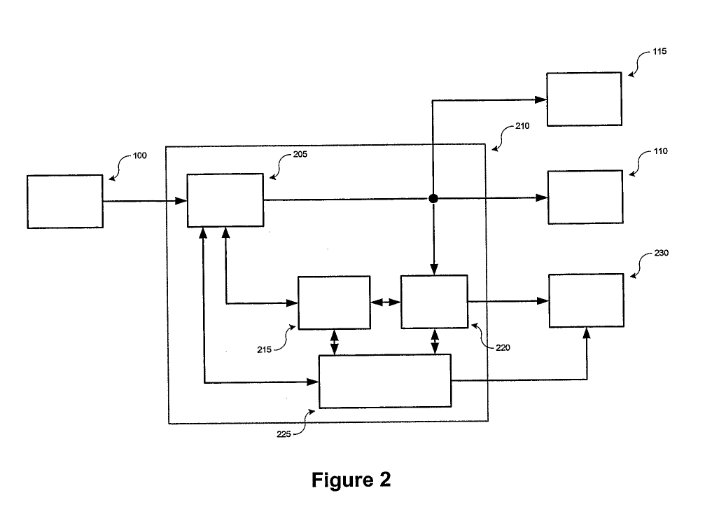

FIG. 2 depicts a first embodiment 210 of the present invention for use in alleviating the ability of a spying application to read comprehensible input data. The first embodiment 210 includes an input handler 205, a random data provider 215, an input descrambler 220, and controller 225. By way of example, the input handler 205, the random data provider 215, and the input descrambler 220 include device drivers. In one embodiment, controller 225 includes a user interface.

The input handler 205 interacts with random data provider 215 to intersperse and encrypt the input data. In one embodiment, the random data provider 215 generates random data and passes this random data to the input handler 205. The input handler 205 intersperses input data received from the physical input device 100 with the random data received from the random data provider 215, thereby forming an interspersed input data. Thereafter, the interspersed and encrypted input data is passed by the input handler 205 to an operating system of the computer system which distributes the interspersed and encrypted input data to software applications. Software applications which receive the interspersed and encrypted input data from the operating system may include the random data provider 215 and the input descrambler 220. It would be appreciated by a person skilled in the art that the spying application 110 may also be able to listen to the interspersed and encrypted input data from the operating system though it would have difficulty in extracting the input data.

The random data provider 215, transmits information to the input descrambler 220 regarding the way in which the random data has been generated. The input descrambler 220 is able to extract the input data from the scrambled input data based on this received information. The random data information is passed from the random data provider 215 to the input descrambler 220 via an encrypted file. In another embodiment, the random data information is passed from the random data provider 215 to the input descrambler 220 via the random access memory of the computer system.

Thereafter, the extracted input data is selectively accessible by the authorised software application 230, where the authorised software application 230 may be the same application that implements and executes the system provided by the embodiment. In contrast, if input data is just transported via a prior art system of device drivers and operating system input handlers, the input data becomes accessible to spying applications.

The operations of the input handler 205, random data provider 215, the input descrambler 220, and authorised software applications, may be controlled by controller 225. Amongst other things, controller 225 is able to send basic commands and/or data including ‘start’, ‘stop’ and ‘reset’. In one embodiment, controller 225 is able to send to input handler 205 basic commands as well as control data, such as random data that will be used by the input handler 205 for interspersing and/or encrypting the input data. The same control data, which are random data, are also sent to input descrambler 220 so that the interspersed and/or encrypted input data can is able to be descrambled.

In another embodiment, the random data provider 215 interacts with the input handler 205 to perform encryption on the input data. The encryption is performed by the random data provider 215 based on the raw input data passed to it by the input handler 205. The encrypted data is then passed from random data provider 215 to the input handler 205. The encrypted data is then outputted by the input handler 205. Encryption algorithms, such as RC4, can be used to perform data encryption. The input descrambler 220 decrypts the encrypted data and selectively passes the decrypted input data to authorised software applications. In a further modification to the current embodiment, the random data provider 215 intersperses random data into the encrypted data. In a separate modification to the current embodiment, the random data provider 215 intersperses random data with the original input data prior to encryption.

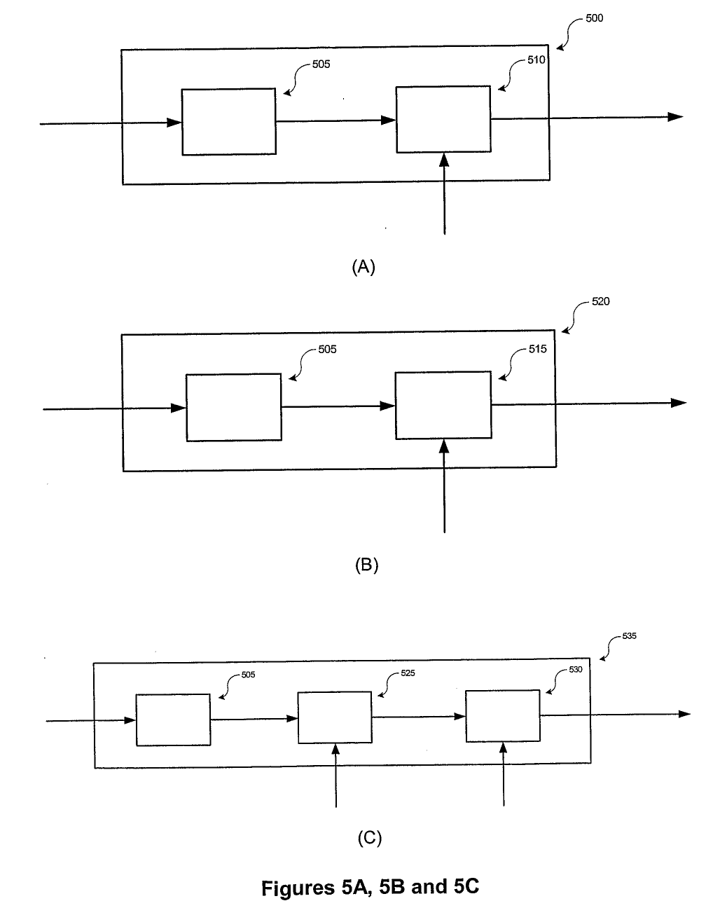

In another embodiment of the invention, the input handler 205 interacts with the random data provider 215 to perform encryption on the input data. The encryption is performed by the input handler 205 based on the raw input data that it receives. Encryption information, such as the encryption key, is passed from the random data provider 215 to the input handler 205. The encrypted data is then outputted by the input handler 205. Encryption algorithms, such as RC4, can be used to perform data encryption. The input descrambler 220 decrypts the encrypted data and selectively passes the decrypted input data to authorised software applications. In a further modification to the current embodiment, the input handler 205 intersperses random data into the encrypted data. In a separate modification to the current embodiment, the input handler 205 intersperses random data with the original input data prior to encryption. In one embodiment, the system shown in FIG. 2, is implemented by a software application running under the Microsoft Windows operating system. Random data provider 215 generates random characters using a random number generator, such as ‘rand’. The random characters are then sent for distribution using a Windows API function, such as ‘SendInput’, which passes the random character to an input handler 205 provided by the operating system. Furthermore, the generated random character is added to an application-defined First-In-First-Out (FIFO) queue for later retrieval by the input descrambler 220. The pseudo-code for this embodiment is shown in Listing 1. Listing 2 shows the pseudo-code that performs the functions of input descrambler 220, which receives simulated key-presses via the operating system. Characters resulting from simulated key-presses are discarded, whilst data are sent to a pre-determined destination window. Some key-loggers attach themselves as a Windows hook procedure in order to listen in on key strokes that are distributed around the system. The Windows hook procedures are usually compiled as Dynamic Link Libraries (DLL), and loaded without users' knowledge using, for example, Trojan applications. Windows maintain several independent chains of hook procedures. An application with a hook procedure installed in one of the chains allows it to monitor messages of a particular type, depending on which chain the hook is installed in. It is possible to create and load an appropriate and malicious Windows hook procedure that listens in on the characters that get sent to destination windows. Listing 3 shows how this problem can be mitigated by installing a blocking hook procedure before the main loop, and removing the blocking hook procedure once the main loop completes. The blocking hook procedure blocks all messages of the same type as the one that will be sent to the destination window from reaching any other installed hook procedures. This can be used to prevent any malicious hook procedures from receiving characters that are sent to the destination window. This embodiment can be extended by another illustrative embodiment whereby input handler 205 includes a second device driver designed to perform encryption on the input data. In this case, the second device driver attaches to an existing stack of device drivers. In the context of the above mentioned embodiment and the currently described extension embodiment, the input handler 205 may be arranged as shown in FIG. 5C as input handler 535, which is suitable for use in the first embodiment. The first device driver 505 reads input from the physical device. The second device driver 525 reads the data read by the first device driver 505. The operating system input handler 530 is provided by the operating system, which resides outside of the device stack. The operating system input handler 530 is a software component that may reside in the kernel program space, the user program space, or some combination thereof. The operating system input handler 530 reads data from the second device driver 525 and intersperses that data with random data, which can be achieved by using operating system functions such as the Windows ‘SendInput’ function as described above and in Listing 1. Both the second device driver 525 and operating system input handler 530 accept random data as input from the random data provider 215. The second device driver performs encryption by mapping an input datum to another datum that is within the set of allowable data (see Listing 4). For example, an input key stroke value of ‘A’ is mapped to a randomly selected key stroke value of ‘T’, where the set of allowable data is the set of key stroke values from ‘A’ to ‘Z’ of the English alphabet. Furthermore, once an input key stroke value has been mapped to a different key stroke value, that mapping is randomly modified or a new set of mappings is provided so that the next mapping of the key stroke value of ‘A’ may be another random key stroke value. Mapping information is provided by random data provider 215, where an example of the mapping information is “B, Z, E, J, . . . ”, which is a set of the 26 English alphabet characters that have been selected in random order. The position of a character in this set corresponds to the input key stroke value, where the first position of the character ‘B’ in this set corresponds to the input character value of ‘A’. The value of a character in this set corresponds to the key stroke value to map to. For example, ‘A’ maps to ‘B’, ‘B’ maps to ‘Z’, ‘C’ maps to ‘E’, ‘D’ maps to ‘J’ and so on and so forth. In one embodiment, random data provider 215 provides a new set of mapping information every time an input data is received so that a new map is used each time. In any case, random data provider 215 also provides the mapping information to input descrambler 220 so that the scrambled input data can be descrambled. The input descrambler 220 performs descrambling in two steps (see Listing 5). The first step uses the random data from the random data provider 215 to reverse the effects of the interspersing of random data performed by the operating system input handler 530. The second 5 step involves reversing the mapping of input key stroke values to random key stroke values using the mapping information received from random data provider 215. The process of reversing the mapping may involve using the received random key stroke value to look up the entry in the mapping information that has the same value. The index of this entry is then the original input key stroke value, 10 which can then be outputted by the input descrambler 220.

```
while simulating input
    c = GenerateRandomCharacter( )
    AddToFIFOQueue(c)
    SendInput(c)
end while
```

### Listing 1

```
destinationWindow = GetDestinationWindow( )
    while application is running
    WaitForNextInputCharacterFromOperatingSystem( )
    c = GetInputCharacter( )
    x = GetHeadCharacterFromFIFOQueue( )
    if c equal x then
        RemoveHeadCharacterFromFIFOQueue( )
    else
        SendCharacterToDestinationWindow(c, destinationWindow)
end while
```

### Listing 2

```
LoadBlockingHookProcedure( )
destinationWindow = GetDestinationWindow( )
while application is running
    WaitForNextInputCharacterFromOperatingSystem( )
    c = GetInputCharacter( )
    x = GetHeadCharacterFromFIFOQueue( )
    if c equal x then
        RemoveHeadCharacterFromFIFOQueue( )
    else
        SendCharacterToDestinationWindow(c, destinationWindow)
end while
UnloadBlockingHookProcedure( )
```

### Listing 3

```
while true
    If new random mapping information available then
        Copy random mapping information to internal mapping table
    else if input data available then
        Use input data as index into mapping table
        Read mapping table entry with input data as index
        Output value read from mapping table
end while
```

### Listing 4

```
LoadBlockingHookProcedure( )
while scrambling is enabled
    WaitForNextInputCharacterFromOperatingSystem( )
    /* comment: step 1, reverse interspersing of random data */
    c = GetInputCharacter( )
    x = GetHeadCharacterFromFIFOQueue( )
    if c equal x then
        /* comment: c is a random interspersing character */
        RemoveHeadCharacterFromFIFOQueue( )
    else
        /* comment: step 2, reverse mapping of input data */
        Copy random mapping information to internal mapping table
        For i in each index of mapping table
            if mapping table entry at index i has value c then
                d = i
                break out of closest enclosing For loop
        SendCharacterToDestinationWindow(d, destinationWindow)
end while
UnloadBlockingHookprocedure( )
```

### Listing 5

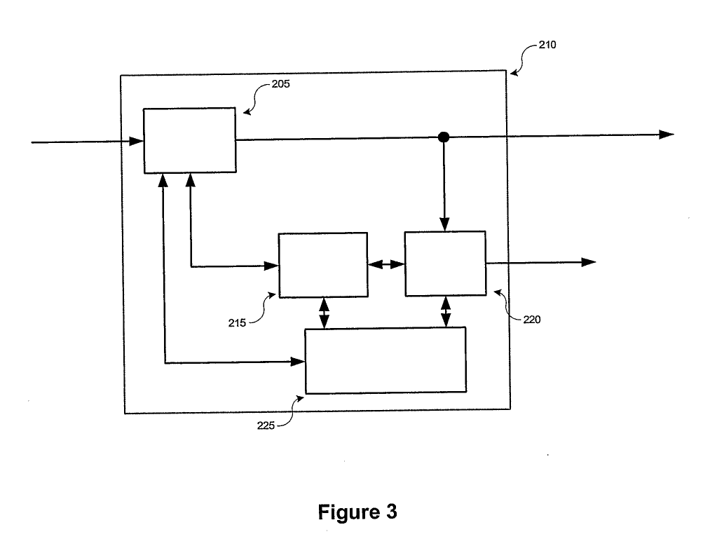

FIG. 3 depicts the first embodiment as a modular system that is able to be interfaced with a variety of computing devices wherein the input of the modular system can be interfaced with an input device and the output of the modular system can be interfaced with a device which accepts data.

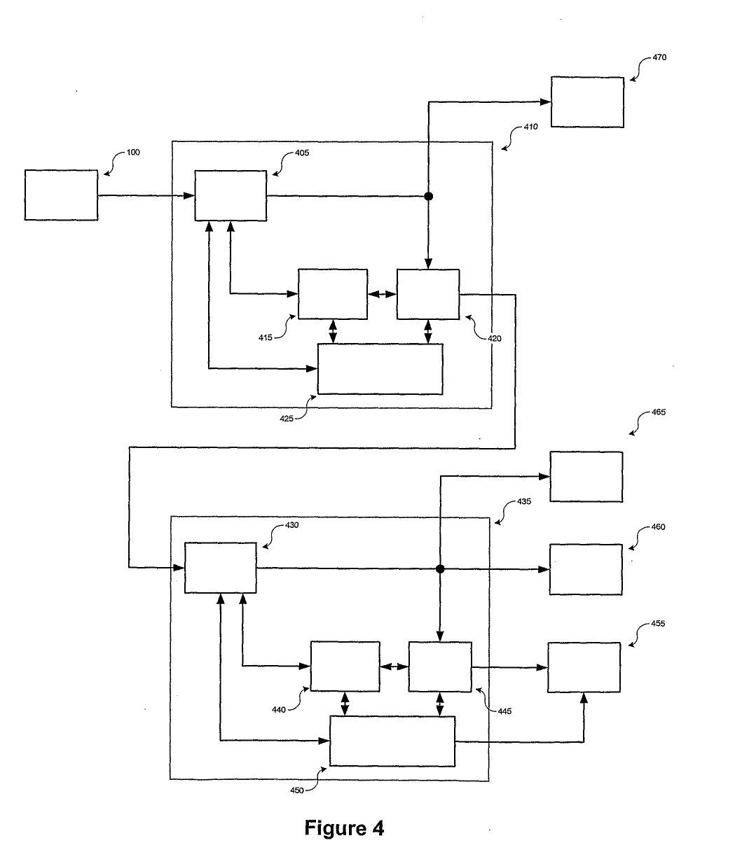

The modularity of the first embodiment 210 conveniently allows a plurality of first embodiment systems to be chained together as shown FIG. 4 to provide enhanced security. As shown, a first and a second first embodiment system 410 and 435 are chained together which may be particularly useful in a computing system that contains a plurality of input handlers, such as the input handlers 405 and 430, and, the output of each is vulnerable to spying applications. In this chained arrangement, the input data is entered via the physical device 100 which in turn is read by a first input handler 405. Random data is fed to the input handler 405 from a first random data provider 415. A first input descrambler 420 receives the scrambled input data from the first input handler 405 and extracts the input data from the received scrambled input data. The extracted input data is then passed to a second input handler 430 from the first input descrambler 420. Random data from a second random data provider 440 is fed to the second input handler 430 where it is used for scrambling the input data received from the first input descrambler 420.

The second input descrambler 445 then extracts the input data from the scrambled input data received from the second input handler 430. This extracted input data is then passed to the authorised software application 455, where the authorised software application 455 may be the same application that implements and executes the system provided by the present embodiment. FIG. 4 also shows two points in which spying applications 460 and 470 are able to spy on the input data. The authorised user application 455 is protected from the spying applications 460 and 470 by the first and second systems 410 and 435. The unauthorised user application 465 may also receive the scrambled input data, but does not have the ability to comprehend the data. An example, in which the arrangement shown in FIG. 4 may typically be applicable, is when the first input handler 405 is a device driver and the second input handler 430 is an operating system input handler.

When the chained arrangement is used, it is important to ensure that the scrambled input data that is output from the first input handler 405 is not easily correlated with the scrambled input data that is outputted by the second input handler 430, otherwise, it may be possible for the spying applications 460 and 470 to be able to compare the outputs of the first input handler 405 and the second input handler 430 so as to extract the input data. In the first embodiment, one of the steps used to alleviate the ability of a spying application to correlate data in this fashion, is to randomise the positions in which input data is interspersed with random data. However, even if the interspersed positions are randomised, some correlation may still exist due to the fact that the input data does not typically change between the output of the first input handler 405 and the second input handler 430, although the random data does generally change.

In the first embodiment, random data is generated such that it is statistically similar to the input data. Alternatively, the same random data can be used in the scrambling process in both the first input handler 405 and second input handler 430.

In one embodiment of the first embodiment, the scrambled input data produced by the first and second input handlers 405 and 430 include further encryption using an RC4 stream cipher. In another embodiment of the first embodiment, the scrambled input data produced by the first and second input handlers 405 and 430 include encryption by randomly mapping input data to another set of data. The controllers 425 and 450 control the operation of the respective input handlers, random data providers and input descramblers by providing commands and/or data such as ‘start’, ‘stop’ and ‘reset’.

FIGS. 5A, 5B and 5C depict three arrangements of the input handler which are suitable for use in the first embodiment system. In FIG. 5A, the input handler 500 is based on the chaining of device drivers 505 and 510 where the underlying operating system is adapted to support the chaining of device drivers, where a chain of device drivers is also known as a device stack. The chaining of device drivers is a feature that is supported by some computer operating systems. The first device driver 505 obtains input data from a physical input device. The input data is processed and passed up the chain of device drivers up to a second device driver 510 which serves as an input scrambler. The second device driver 510 also accepts random data and intersperses this with the input data to produce at its output, a scrambled input data. In another embodiment, the second device driver 510 accepts random data, and uses the random data to encrypt the input data. In one embodiment, the encryption step is carried out by using the random data to randomly map an input symbol to another input symbol. For example, the input symbol may be a keyboard key value, mouse coordinates, or mouse button clicks. The map may selectively and randomly change with every input symbol read.

Alternatively, FIG. 5B depicts an input handler 520 that uses an operating system input handler 515. The first device driver 505 obtains input data from a physical input device, processes this data, and then passes it to the operating system input handler 515. The operating system input handler 515 accepts random data and intersperses this with the received input data to produce a scrambled input data. The output of the operating system input handler 515 is distributed by the operating system to relevant software applications. In another embodiment, the operating system input handler 515 accepts random data, and uses the random data to encrypt the input data. In one embodiment, the encryption step is carried out by using the random data to randomly map an input symbol to another input symbol. For example, the input symbol may be a keyboard key value, mouse coordinates, or mouse button clicks. The map may selectively and randomly change with every input symbol read.

Alternatively, FIG. 5C depicts an input handler 535 that includes a first device driver 505, second device driver 525 and operating system input handler 530. The first device driver 505 and second device driver 525 form a chain of device drivers, also known as a device stack. The second device driver 525 reads the data read by the first device driver 505. The operating system input handler 530 is provided by the operating system, which resides outside of the device stack. The operating system input handler 530 is a software component that may reside in the kernel program space, the user program space, or some combination thereof. Random data is provided by a random data provider to the second device driver 525 and operating system input handler 530. In one embodiment, the second device driver 525 performs encryption on the input data, and the operating system input handler 530 reads data from the second device driver 525 and intersperses that data with random data to form the scrambled input data. In another embodiment, the second device driver 525 reads data from the first device driver 505 and intersperses that data with random data, and the operating system input handler 530 reads data from the second device driver 525 and encrypts it to form the scrambled input data. In one embodiment, the encryption step is carried out by using random data to randomly map an input symbol to another input symbol. For example, the input symbol may be a keyboard key value, mouse coordinates, or mouse button clicks. The map may selectively and randomly change with every input symbol read.

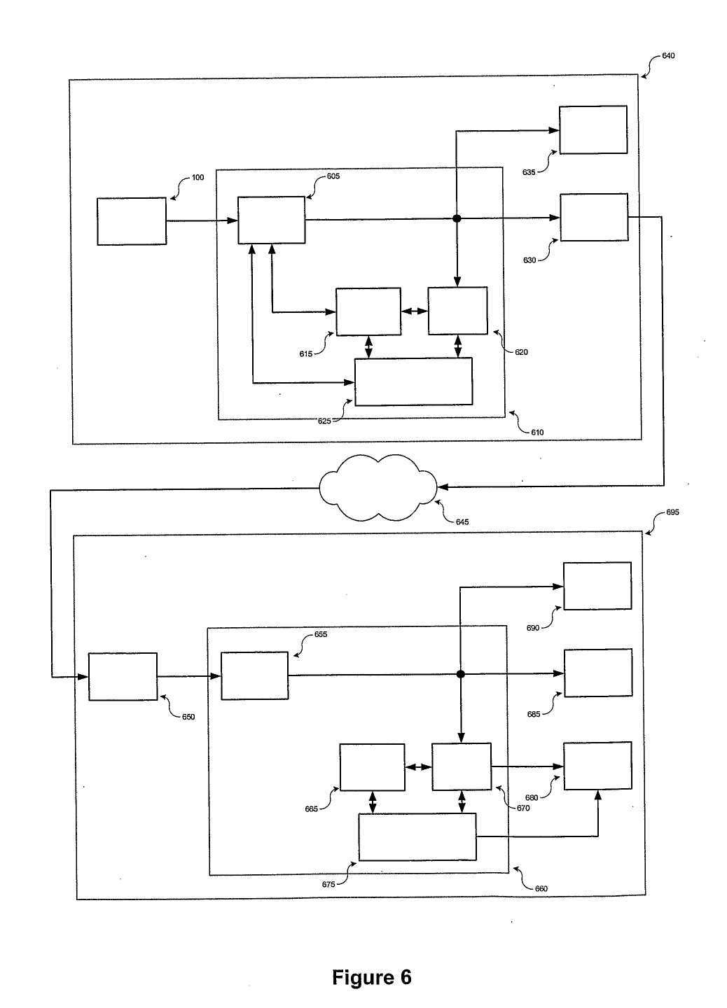

FIG. 6 illustrates the chaining of a first and a second first embodiment system, wherein the first and second systems are located in first and second computing systems 640 and 695 respectively, which are interconnected via a communication link such as the Internet, an Intranet, a LAN, a WAN, or the like. By way of example only, the first computing system 640 may be a user's personal computer with an Internet application 630 (eg. an Internet browser) running on it. The second computing system 695 may be a web server. The Internet applications 630 and 650 are applications that provide the facilities for communicating data with other computing systems using an internal/external network or Internet. The authorised user application 680 is a server of web pages, which receives input data, such as credit card information for processing, where the authorised software application 680 may be the same application that implements and executes the system provided by the present embodiment

The first system 610 includes a first input handler 605, a first random data provider 615, a first input descrambler 620, and a first controller 625. The first input handler 605 is implemented as a device stack in accordance with the arrangement shown in FIG. 5A, it receives an input data from the physical device 100 (eg. representing a user's credit card details) and scrambles this using random data generated by the first random data provider 615 to produce a scrambled input data. It would be further appreciated by a person skilled in the art that the first input handler 605 that performs scrambling of the input data may be located within the physical device itself.

The first input handler 605 includes encrypting the input data as a part of the scrambling process before passing the scrambled input data on to the Internet application 630. The first input handler 605 includes using an RC4 stream cipher for performing encryption. In this case, the random data provided by the first random data provider 615 may be used as an initialisation vector for the RC4 stream cipher. The initialisation vector is extractable from the encrypted data for instance, by breaking the initialisation vector into segments and interspersing the segments within the scrambled input data in a defined, but non-obvious, manner. The method of encrypting input data operates in addition to any encryption that may already be used, such as the SSL protocol.

The second system 660 is also pre-programmed with knowledge of the encryption method which it uses to decrypt the received scrambled input data. Also in this arrangement, the first input descrambler 620 does not output since the scrambled input data is transmitted directly to the second system 660 via the Internet connection using the Internet applications 630 and 650.

The second system 660 includes a second input handler 655, a second random data provider 665, a second input descrambler 670, and a second controller 675. The second input handler 655 accepts the scrambled input data from the Internet application 650 and passes it to the second input descrambler 670. The second input descrambler 670 descrambles the received scrambled input data to produce an extracted input data, which is thereafter passed to a protected authorised software application 680. The second input descrambler 670 descrambles the scrambled input data by reversing the steps performed by the input handler 605 and/or applying the appropriate decryption algorithm. The extracted input data that is passed to the authorised user application 680 is protected from spying applications 685 and 635. Unauthorised user application 690 may also receive the scrambled input data, but does not have the ability to comprehend the data.

Thus, it would be appreciated by a person skilled in the art that the first system 610 functions as a scrambling module for input data, whilst the second system 660 serves as a corresponding descrambling module.

The arrangement depicted in FIG. 6 illustrates how, in the first embodiment, input data is scrambled at a low level, such as the device driver level or within the physical device, that is very close to the physical device and transported via a series of mediums, such as the Internet, which are potentially vulnerable to spying applications, before being descrambled as late as possible and used by the final receiving application.

The controllers 625 and 675 in FIG. 6 may control the operation of the input handlers, random data providers and input descramblers by providing commands and/or data such as ‘start’, ‘stop’ and ‘reset’.

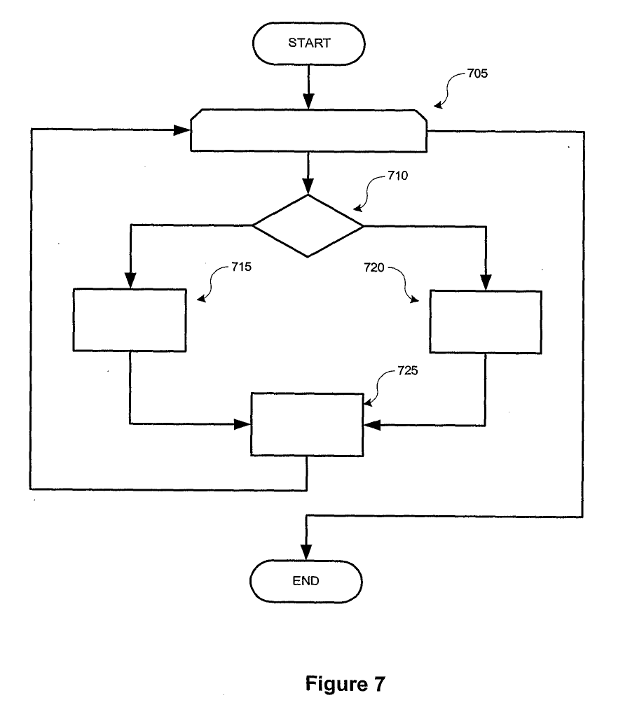

FIG. 7 illustrates the flowchart of one embodiment of the second device driver 510. The flowchart also applies to one embodiment of the operating system input handler 515. This flowchart illustrates how user input data can be interspersed with random data. “While scrambling is enabled” step 705 is a loop that iterates whilst scrambling is enabled. A check is made at step 710 to see if user input is available at every cycle of the algorithm. In one embodiment, the rate of the cycle, or the delay between cycles, is fixed to a pre-determined value. In another embodiment, the rate of the cycle is changes randomly between iterations. If input data is available, then that data is read in step 715 and outputted in step 725. Otherwise, random data is read from another input in step 720 and outputted in step 725.

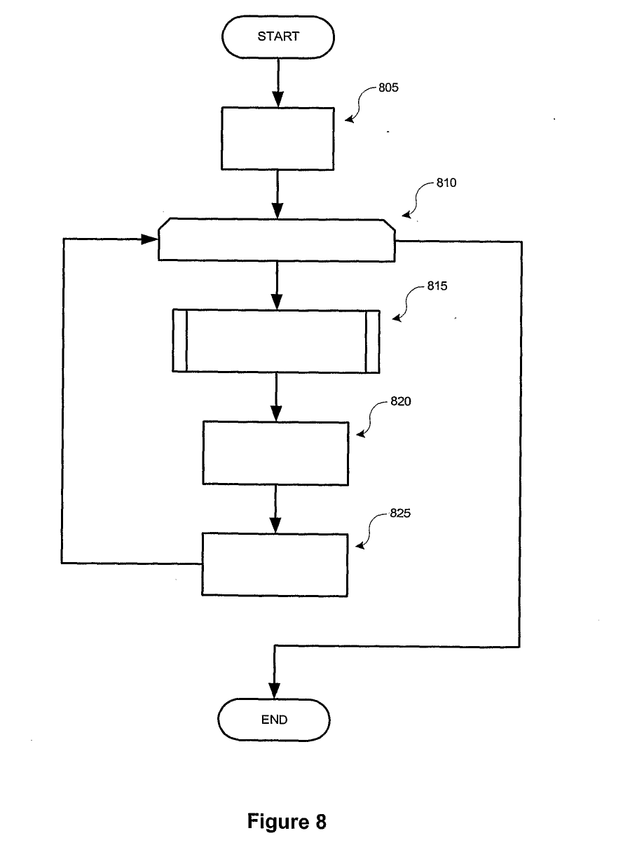

FIG. 8 is the flowchart of one embodiment of the random data provider, such as the random data provider 215, 415 and 440, adapted to generating random data that will be used for interspersing into input data to form an interspersed input data. A random seed is first obtained in step 805 and used to initialise a random number generator. For every cycle of the algorithm in loop 810 that keeps iterating whilst scrambling is enabled, in step 815, the random data provider obtains a random integer by calling an appropriate random number generator, such as the ‘rand’ function in the C programming language. However, in many cases, the ‘rand’ function is too easy to deduce and reproduce. Alternative methods of generating random numbers are provided by way of Internet RFC 1750, “Randomness Recommendations for Security”, which describes cryptographically strong random number generation methods, such as those using the thermal noise from existing inputs from sound cards, and the Blum Blum Shub sequence generator. In step 820, the random numbers so obtained are then normalised into the range of valid numbers, such as the range of ASCII characters. The normalised data is then outputted in step 825. Even with normalisation, care must be taken to ensure that the random ASCII characters generated should be statistically similar to the input data in order for the user input data to be significantly indistinguishable from random data. The normalised numbers are then outputted by the random data provider, such as random data provider 215, 415 and 440.

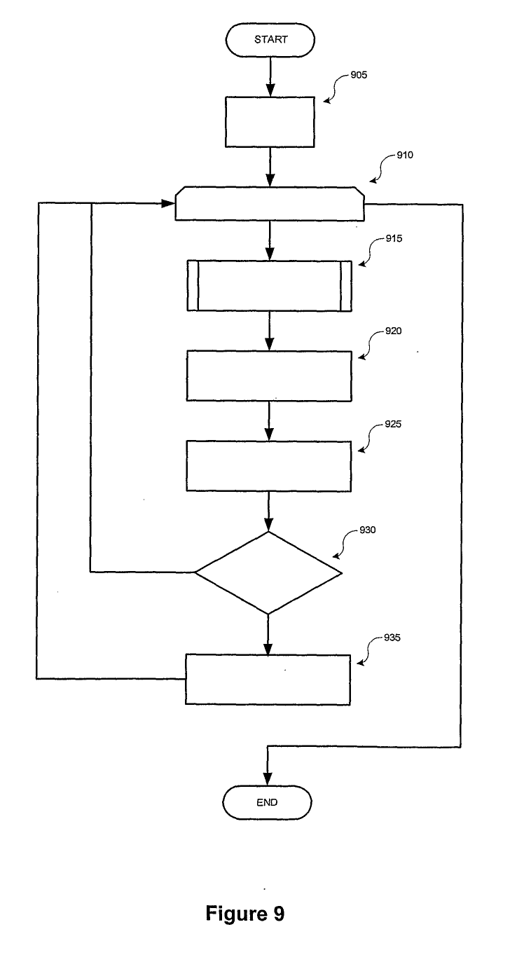

FIG. 9 is the flowchart of one embodiment of the functional operation of an input descrambler such as input descramblers 220, 420 and 445. A random seed is first obtained in step 905 and used to initialise a random number generator. For every cycle of the algorithm in loop 910 that keeps iterating whilst scrambling is enabled, in step 915, the input descrambler obtains the next expected random integer by, for example, calling the ‘rand’ function in the C programming language. In another embodiment, the next expected random integer is communicated to it by the random data provider, such as random data provider 215, 415 and 440. In another embodiment, the next expected random integer is obtained from an encrypted file created by the random data provider. Encryption, such as 3DES, is used to encrypt the random data file to mitigate the possibility of spyware/keylogger applications from obtaining the data. Furthermore, a message authentication code can be generated for the random data and stored in the file prior to encryption. In this case, hashing algorithms such as MD5 can be used. The keys used for the encryption is known to both the random data provider and input descrambler, so they do not need to be transferred in any way. The initialisation vectors for the encryption algorithms can be generated randomly. In step 920, the random numbers so obtained from the encrypted file are then normalised into the range of valid numbers, such as the range of ASCII characters. The next input data character is then read by the input descrambler in step 925. The input character just read is then compared to the next expected random character in step 930, and if they are they same then the input character is a randomly generated character, so it is ignored. Otherwise, if the input character just read is different from the next expected random character, then the input character is a valid user input data, so in step 935 it is outputted by the input descrambler, such as input descrambler 220, 420 and 445.

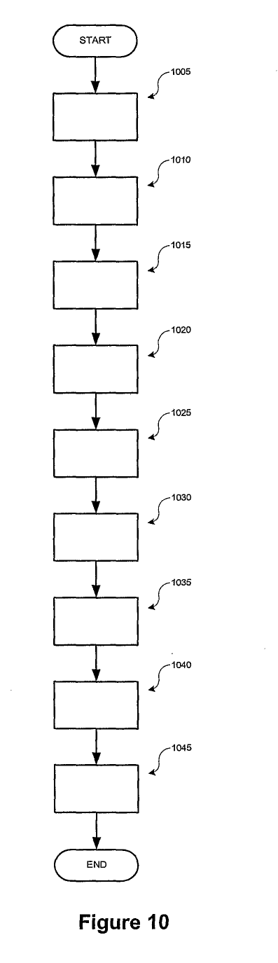

FIG. 10 is a flowchart of one embodiment of the controller, such as controller 225, 425 and 450. In one embodiment, the controller includes a user interface. The first processing step 1005 in this embodiment is the initialisation of the random data provider and input descrambler. In step 1010, a random seed is then selected, which is then sent to the random data provider and input descrambler in step 1015. A particular scrambling mode is set, if any, in step 1020. In step 1025, user configuration options are then obtained via the user interface. Example user configuration options include the delay between iterations of the random data provider and input descrambler. Commands and/or data are then sent to the input handler in step 1030, random data provider in step 1035 and input descrambler in step 1040. Example commands include ‘start’, ‘stop’ or ‘reset’. In step 1045, commands and/or data are also sent to the protected user application to enable it to accept input directly from the input descrambler, instead of accepting input from the normal chain of input handlers, which is susceptible to spying.

In certain embodiments, a “top-most window” is generated which at least partially conceals extracted input data which is presented on a display monitor by an authorised software application

In one embodiment, the steps involved in concealing input data on the display screen includes:
(i) obtaining coordinates indicative of the input data as presented on the display;
(ii) estimating a set of dimensions of a top-most window which will be used to block the display of the input data;
(iii) generating a top-most window having the estimated dimensions;
(iv) positioning the top-most window on the display so as to at least partially conceal the presented input data.

The applicant envisages that embodiments of the present invention will have a wide range of applications, for example, for use in securing: user inputs into Internet chat applications; the typing of e-mails; the creation of text documents; the entering of usernames and passwords; the input of credit card details; and the input other sensitive information. Embodiments may also be applicable to securing the input of mouse movements and button presses, and the input of user data using other physical devices. By choosing the appropriate encryption scheme, such as using the public key of a trusted user, the exposure of users entering sensitive data into phishing websites is significantly diminished.

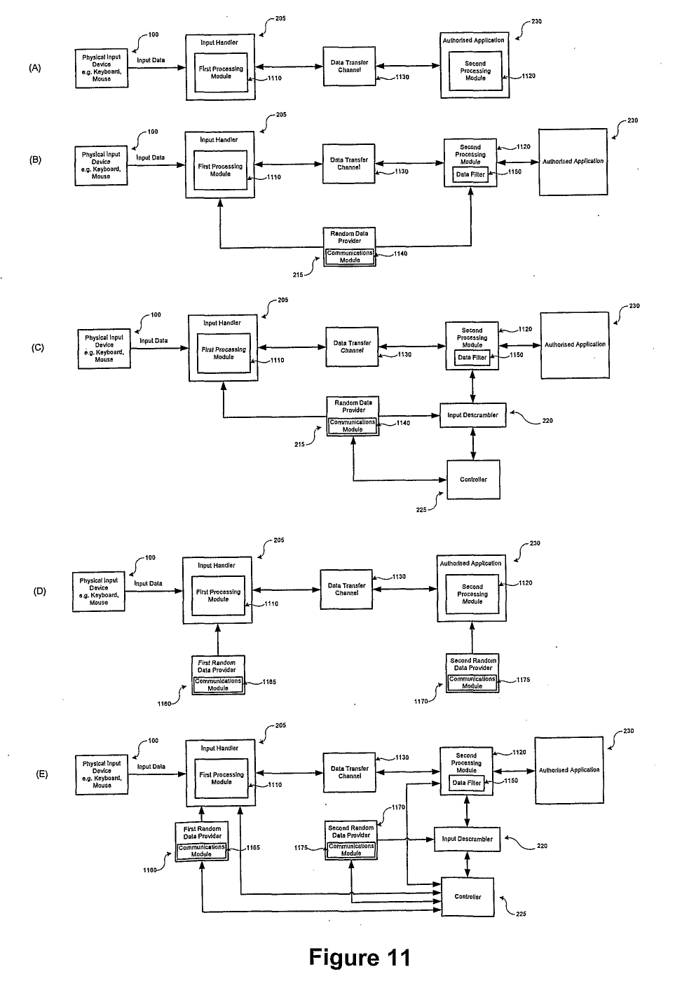

FIG. 11 depicts one embodiment of the present invention for use in alleviating the ability of spying applications to read comprehensible input data. FIG. 11(A) depicts an input handler 205 comprising a first processing module 1110. The first processing module 1110 receives input data from input device 100. The first processing module 1110 encrypts, scrambles and/or intersperses the received input data. The encrypted, scrambled and/or interspersed input data is then transmitted to a second processing module 1120 via a data transfer channel 1130. The second processing module 1120 then extracts the input data from the encrypted, scrambled, and/or interspersed input data, and provides the extracted input data to authorised application 230.

FIG. 11(B) depicts an input handler 205 comprising a first processing module 1110. The first processing module 1110 receives input data from input device 100. The first processing module 1110 encrypts, scrambles and/or intersperses the input data with data derived from the data provided by random data provider 215. The encrypted, scrambled and/or interspersed input data is then transmitted to a second processing module 1120 via a data transfer channel 1130. The second processing module 1120 comprises a data filter 1150. The second processing module 1120 then operates in co-operation with random data provider 215 to extract the input data from the encrypted, scrambled, and/or interspersed input data. The extracted input data is then provided to authorised application 230 via data filter 1150. Communications module 1140 operates to limit the number of connections to random data provider 215.

FIG. 11(C) depicts an input handler 205 comprising a first processing module 1110. The first processing module 1110 receives input data from input device 100. The first processing module 1110 encrypts, scrambles and/or intersperses the input data with data derived from the data provided by random data provider 215. The encrypted, scrambled and/or interspersed input data is then transmitted to a second processing module 1120 via a data transfer channel 1130. The second processing module 1120 comprises a data filter 1150. Input descrambler 220 then operates in co-operation with at least one of second processing module 1120, random data provider 215 and controller 225 to extract the input data from the encrypted, scrambled, and/or interspersed input data. The extracted input data is then provided to authorised application 230 via data filter 1150. Communications module 1140 provided by random data provider 215 operates in co-operation with controller 225 to limit the number of connections to the random data provider 215.

FIG. 11(D) depicts an input handler 205 comprising a first processing module 1110. The first processing module 1110 receives input data from input device 100. The first processing module 1110 encrypts, scrambles and/or intersperses the received input data with data derived from the data provided by first random data provider 1160. The encrypted, scrambled and/or interspersed input data is then transmitted to a second processing module 1120 via a data transfer channel 1130. The second processing module 1120 then extracts the input data from the encrypted, scrambled, and/or interspersed input data using data derived from the data provided by second random data provider 1170. The second processing module 1120 then provides the extracted input data to authorised application 230. Communications module 1165 provided by first random data provider 1160 and communications module 1175 provided by second random data provider 1170 operate to limit the number of connections to the first random data provider 1160 and second random data provider 1170 respectively.

FIG. 11(E) depicts an input handler 205 comprising a first processing module 1110. The first processing module 1110 receives input data from input device 100. The first processing module 1110 encrypts, scrambles and/or intersperses the input data with data derived from the data provided by first random data provider 1160. The encrypted, scrambled and/or interspersed input data is then transmitted to a second processing module 1120 via a data transfer channel 1130. Any of the second processing module 1120, controller 225, input descrambler 220 and second random data provider 1170 may then operate in co-operation to extract the input data from the received encrypted, scrambled and/or interspersed input data. The extracted input data is then transmitted to authorised application 230 via data filter 1150. Communications module 1165 provided by first random data provider 1160 and communications module 1175 provided by second random data provider 1170 operate in co-operation with controller 225 to limit the number of connections to the first random data provider 1160 and second random data provider 1170 respectively.

In another embodiment, FIG. 11(E) depicts an input handler 205 comprising a first processing module 1110. The first processing module 1110 receives input data from input device 100. The first processing module 1110 encrypts, scrambles and/or intersperses the input data with data derived from the data provided by first random data provider 1160. On receiving input data, the first processing module 1110 sends a first signal to second processing module 1120 via data transfer channel 1130. The second processing module 1120 comprises a data filter 1150. On receiving the first signal from the first processing module 1110, the second processing module 1120 transmits a second signal to controller 225. The controller 225 then communicates with the first processing module 1110 and may instruct the first processing module 1110 to transmit the encrypted, scrambled and/or interspersed input data to the second processing module 1120. Any of the second processing module 1120, controller 225, input descrambler 220 and second random data provider 1170 may then operate in co-operation to extract the input data from the received encrypted, scrambled and/or interspersed input data. The extracted input data is then transmitted to authorised application 230 via data filter 1150. Communications module 1165 provided by first random data provider 1160 and communications module 1175 provided by second random data provider 1170 operate in co-operation with controller 225 to limit the number of connections to the first random data provider 1160 and second random data provider 1170 respectively.

In some embodiments, any or all of the above random data providers may provide data that are not random. Merely by way of example, the data provided by the random data providers, such as first random data provider 1160 and second random data provider 1170, may include non-random data, such as pre-determined data and control signals. The control signals may be signals propagated from, or derived from, the control signals provided by controller 225.

The above-mentioned data transfer channel 1130 may be prone to spying by malicious applications. Merely by way of example, data transfer channel 1130 includes the use of data structures, such as message queues, and messaging packets, such as the I/O request packet. A spying application may secretly obtain input data by peeking into the data in message queues or into message structures as they are delivered to a software application. The present invention mitigates the threat of spying by malicious applications by encrypting, scrambling and/or interspersing the input data.

In some embodiments, any or all of the above-mentioned controllers, second random data providers, and/or input descramblers may operate with one or more authorised applications. In one embodiment, any of the second random data providers, input descramblers and controllers may be provided by the second processing module. In one embodiment, the first random data provider may be provided by the first processing module.

In some embodiments, the number of connections to the first random data provider 1160, second random data provider 1170, and random data provider 215 are limited to a preset number. The number of connections may be maintained and monitored by the respective communications modules provided in each random data provider, and/or controller 225. Merely by way of example, the preset maximum number of connections may be some number, N, greater than or equal to one, where the data provided by the random data providers are only allowed to be transmitted to N destinations. The destinations may include any of the above-mentioned first processing modules, second processing modules, input descramblers, data filters, and controllers.

In one embodiment, as shown in FIG. 11 (B)(C)(E), a second processing module 1120 is provided externally to authorised application 230. In another embodiment, as shown in FIG. 11(A)(D), authorised application 230 comprises a second processing module 1120. In this embodiment, the second processing module 1120 may be provided by the authorised application 230 by:
being built into the authorised application during application creation;
code injection as is typically used in various forms of hooking, such as API hooking, kernel hooking, import address table (IAT) hooking, I/O request packet (IRP) hooking, interrupt descriptor table (IDT) hooking, system service descriptor table (SSDT) hooking, message hooking and the like; and
runtime patching, where executable code is patched during runtime to modify the behaviour of one or more functions.

In one embodiment, any of the above-mentioned first processing module 1110, second processing module 1120, random data provider 215, first random data provider 1160, second random data provider 1170, communications module 1140, communications module 1165, communications module 1175, input descrambler 220, controller 225, and data filter 1150 may be provided at least in part by a software application, hardware device, software daemon, software module, software service (such as a Microsoft Windows service), user-mode driver, and/or kernel-mode driver.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The reference to any prior art in this specification is not, and should not be taken as, an acknowledgment or any form of suggestion that that prior art forms part of the common general knowledge.

1. A method for use-in controllably concealing an input data that has been entered into a computer system via an input device, from being comprehended by a spying application during transportation of the input data across a communication link of the computer system, the method including the steps of:
(i) interspersing the input data with random data at a relatively low level to generate interspersed input data, wherein the random data is generated according to a characteristic that is indicative of the input data;
(ii) thereafter, encrypting the interspersed input data at a relatively low level to generate encrypted interspersed input data;
(iii) thereafter, transporting the encrypted interspersed input data across the communication link;
(iv) thereafter, decrypting the encrypted interspersed input data so as to obtain the interspersed input data;
(v) thereafter, extracting the input data from the interspersed input data so as to obtain the input data;
(vi) selectively providing access to the input data by an authorised software application operably connected to the computer system.

2. A method as claimed in claim 1 wherein the steps (i) and (ii) are performed by a first processing module, and, the steps (iv), (v) and (vi) are performed by a second processing module.

3. A method as claimed in claim 2 wherein the first and second processing modules operate on physically separate first and second computer systems respectively, said first and second computer systems being operably connected via the communication link.

4. A method as claimed in any one of claims 1 to 3 wherein the characteristic includes a statistical similarity between the random data and the input data.

5. A method as claimed in any one of claims 1 to 4 wherein the relatively low level includes a device driver level.

6. A method as claimed in claim 5 wherein the device driver includes a device driver of a keyboard input device.

7. A method as claimed in any one of claims 1 to 6 wherein the authorised software application includes a web browser.

8. A method as claimed in any one of claims 2 to 7 wherein the second processing module is adapted to intercept the encrypted interspersed input data intended for transportation to at least one of a window, an application, a process, and a thread.

9. A method as claimed in any one of claim 2 to 8 wherein the second processing module includes a data filter.

10. A method as claimed in claim 9 wherein the data filter includes a hook.

11. A method as claimed in any one of claims 1 to 10 including the step of selectively concealing the display of input data on a monitor as the input data is entered into the computer system via the input device.

12. A system for use in controllably concealing an input data that has been entered into a computer system via an input device, from being comprehended by a spying application during transportation of the input data across a communication link of the computer system, the computer system including a processor communicably connected to:
the input device; and
a memory store which is adapted to store a computer program, wherein the processor is operative with the computer program to perform the method steps in accordance with any one of claims 1 to 11.

13. A computer-readable medium having stored thereon, a data structure generated in accordance with the method steps of any one of claims 1 to 11.

14. A computer-readable medium having computer-executable instructions for performing the method steps in accordance with any one of claims 1 to 11.
